(19) United States
(12) Patent Application Publication
(10) Pub. No.: US 2016/0043548 A1
(43) Pub. Date: Feb. 11, 2016

(54) ROLLING STOCHASTIC OPTIMIZATION BASED OPERATION OF DISTRIBUTED ENERGY SYSTEMS WITH ENERGY STORAGE SYSTEMS AND RENEWABLE ENERGY RESOURCES

(71) Applicant: NEC Laboratories America, Inc., Princeton, NJ (US)

(72) Inventors: Mohammad Chehreghani Bozchalui, Cupertino, CA (US); Chenrui Jin, Manlius, NY (US); Ratnesh K. Sharma, Fremont, CA (US)

(21) Appl. No.: 14/452,822

(22) Filed: Aug. 6, 2014

Related U.S. Application Data
(60) Provisional application No. 61/866,326, filed on Aug. 15, 2013.

(51) Int. Cl. H02J 3/00; G05B 13/04

(52) U.S. Cl. CPC H02J 3/00; G05B 13/041

(57) ABSTRACT

A system and method are provided for an energy distribution system having at least one energy storage system and at least one renewable energy resource. The method includes determining distribution optimal power flow optimization models of components of the distribution system. The components at least include the at least one energy storage system and the at least one renewable energy resource. The method further includes generating a composite model of the distribution system by integrating therein the distribution optimal power flow optimization models. The method also includes optimally scheduling, using a processor-based scheduling optimizer, an operation of resources in the distribution system using at least one of a fixed-window iterative optimization technique and a rolling stochastic optimization technique applied to the composite model.

### RELATED APPLICATION INFORMATION

This application claims priority to provisional application Ser. No. 61/866,326 filed on Aug. 15, 2013, incorporated herein by reference.

### BACKGROUND

1. Technical Field

The present invention relates to signal processing, and more particularly to a rolling stochastic optimization based operation of distributed energy systems with energy storage systems and renewable energy resources.

2. Description of the Related Art

Energy storage systems have been proposed to cope with the volatility of Renewable Energy Resources (RERs) such as solar photovoltaics (PVs) and wind generation in energy systems. If operated properly, ESS can improve system reliability and grid utilization, reduce energy loss, and minimize peak demand.

Rule-based approaches such as time of day or load level based methods are common ways of operation scheduling of energy storage systems in energy distribution systems. Others have also used conventional power flow techniques to run multiple scenarios and schedule the operation of energy storage systems based on off-line analysis of the results.

Existing optimization based methods use approximate models of the system such as a balanced model or a phase-decouple model of the system to model solar PV and energy storage systems in an energy distribution system. However, there is a lack of work directed to integrating photovoltaics and energy storage systems in an unbalanced distribution system with full modeling of ESS.

### SUMMARY

These and other drawbacks and disadvantages of the prior art are addressed by the present principles, which are directed to a rolling stochastic optimization based operation of distributed energy systems with energy storage systems and renewable energy resources.

According to an aspect of the present principles, a method is provided for an energy distribution system having at least one energy storage system and at least one renewable energy resource. The method includes determining distribution optimal power flow optimization models of components of the distribution system. The components at least include the at least one energy storage system and the at least one renewable energy resource. The method further includes generating a composite model of the distribution system by integrating therein the distribution optimal power flow optimization models. The method also includes optimally scheduling, using a processor-based scheduling optimizer, an operation of resources in the distribution system using at least one of a fixed-window iterative optimization technique and a rolling stochastic optimization technique applied to the composite model.

According to yet another aspect of the present principles, a system is provided for performing scheduling for an energy distribution system having at least one energy storage system and at least one renewable energy resource. The system includes an optimization model generator for generating distribution optimal power flow optimization models of components of the distribution system. The components at least include the at least one energy storage system and the at least one renewable energy resource. The system further includes a distribution system composite model generator for generating a composite model of the distribution system by integrating therein the distribution optimal power flow optimization models. The system also includes a processor-based scheduling optimizer for optimally scheduling an operation of resources in the distribution system using at least one of a fixed-window iterative optimization technique and a rolling stochastic optimization technique applied to the composite model.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary processing system 100 to which the present principles may be applied, according to an embodiment of the present principles; and

FIG. 2 is a high-level block diagram showing an exemplary system/method 200 for a rolling stochastic optimization based operation of an unbalanced multi-phase energy distribution system with energy storage systems and renewable energy resources, in accordance with an embodiment of the present principles.

### DETAILED DESCRIPTION OF PREFERRED EMBODIMENTS

The present principles are directed to a rolling stochastic optimization based operation of distributed energy systems with energy storage systems and renewable energy resources. The renewable energy sources can include, but are not limited to, photovoltaics.

Thus, the present principles are directed to energy distribution systems. It is to be appreciated that as used herein, the term “energy distribution system” can encompass an energy micro grid. Moreover, it is to be appreciated that the present principles can be provided for use with unbalanced or balanced energy distribution systems. Further, it is to be appreciated that the present principles can be provided for use with single-phase or multi-phase energy distribution systems. These and other variations of systems to which the present principles can be applied are readily determined by one of ordinary skill in the art given the teachings of the present principles provided herein, while maintaining the spirit of the present principles.

The present principles provide a method and system for optimal operation of Energy Storage Systems (ESS) in distribution networks in coordination with Renewable Energy Resources (RERs). The method relies on a novel optimization formulation that is a multi-period, multi-phase, unbalanced Distribution Optimal Power Flow (DOPF).

The present principles provide a framework for optimal operation scheduling of ESS in unbalanced-multi-phase distribution networks in coordination with RERs. The present principles include optimization problems that are multi-period multi-phase unbalanced DOPF models with detailed mathematical models for solar photovoltaic (PV) generation and ESS.

The present principles use a Rolling Stochastic Optimization (RSO) method to operate energy storage systems in distribution systems with variable loads and generations. The present principles adopt various objective functions related to economy, efficiency, reliability, and so forth. The present principles can be used for operational studies, impact studies, analysis of the system under study like voltage profile at each node, feeder currents, losses, energy drawn from the substation, tap and capacitor operations, and so forth. The preceding applications to which the present principles can be applied are merely illustrative. Thus, one of ordinary skill in the art will contemplate these and various other applications to which the present principles can be applied, while maintaining the spirit of the present principles. The present principles can be used for power flow analysis and also for optimal power flows in an unbalanced system. The present principles include detailed models of solar photovoltaic sources and an energy storage system model can be placed at any node and in any phase of an unbalanced system. Thus, the present principles provide a general framework that incorporates various objectives and constraints related to optimal power system operation.

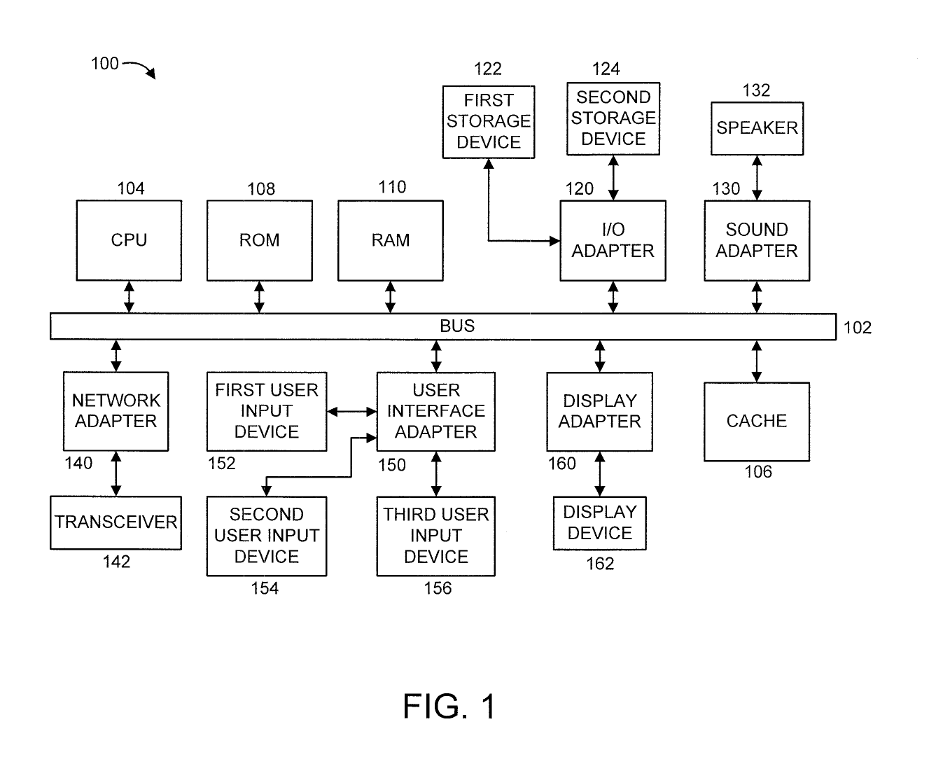

FIG. 1 is a block diagram showing an exemplary processing system 100 to which the present principles may be applied, according to an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operative coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

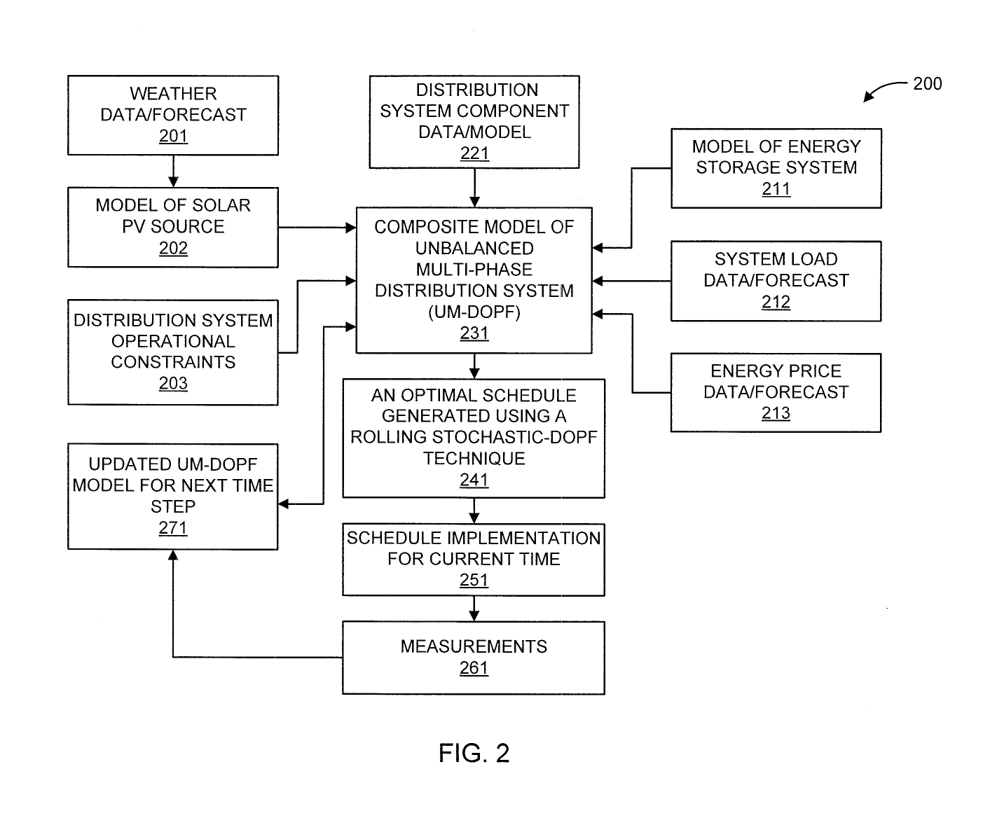

Moreover, it is to be appreciated that system/method 200 described below with respect to FIG. 2 is a system/method for implementing respective embodiments of the present principles. Part or all of processing system 100 may be implemented in one or more of the elements of system/method 200.

FIG. 2 is a high-level block diagram showing an exemplary system/method 200 for a rolling stochastic optimization based operation of an unbalanced multi-phase energy distribution system with energy storage systems and renewable energy resources (e.g., photovoltaics), in accordance with an embodiment of the present principles. In FIG. 2, each of the figure reference numerals collectively represent a respective method step and a device performing the corresponding step.

The following description uses the terms “data” and “forecast”. As used herein, the term “data” refers to actual data as compared to a guess or estimation. In contrast, the term “forecast” refers to a guess or estimation, even if the same is based on data. However, it is to be appreciated that one or both of data and forecasts can be used in accordance with the present principles, while maintaining the spirit of the present principles.

At step/block 221, distribution system component data is determined and input. The distribution system component data can include, but is not limited to, conductors/cables, transformers, switches, and so forth. The distribution system component data can be obtained, e.g., from schematics and so forth using one or more devices. Such devices can include, for example, a scanner and/or so forth. Of course, other sources of this data and ways of obtaining this data can also be used, while maintaining the spirit of the present principles.

In an embodiment, step/block 221 involves generating one or more unbalanced multi-phase distribution system models by an unbalanced multi-phase distribution system model generator. The unbalanced multi-phase distribution system models are generated responsive to at least the distribution system component data.

At step/block 201, weather data/forecast is determined by a weather determination device or received by an input device. The system 200 can either include the weather determination device or be connected to the weather determination device in order to receive the weather data/forecast.

At step/block 202, a mathematical model of a solar photovoltaic (PV) source is generated by an energy source model generator. While a solar PV source is described in this example, the present principles are not limited to solely the preceding and, thus, other types of energy sources can also be used in accordance with the teachings of the present principles, while maintaining the spirit of the present principles. While a single PV source is described, it is to be appreciated that more than one energy source can be included in the distribution system and modeled by the present principles.

At step/block 203, distribution system operational constraints are determined. The constraints can be determined using a distribution system operation constraint determination device, or can be input to the system/method 200 by an input device.

At step/block 211, a mathematical model of an energy storage system is generated by an energy storage system model generator. While a single energy storage system is described, it is to be appreciated that more than one energy storage system can be included in the distribution system and modeled by the present principles.

At step/block 212, system load data/forecast is determined by a system load determination device or received by an input device. In the case of a system load determination device, the device can determine actual system load data and/or a system load forecast. The system 200 can either include the system load determination device or be connected to the system load determination device in order to receive the system load data/forecast.

At step/block 213, energy price data/forecast is determined by an energy price determination device or received by an input device. In the case of an energy price determination device, the device can determine actual energy price data and/or an energy price forecast. The system 200 can either include the energy price determination device or be connected to the energy price determination device in order to receive the energy price data/forecast.

At step/block 231, generate a composite model of the unbalanced multi-phase distribution system (UM-DOPF) by an unbalanced multi-phase distribution system composite model generator. In an embodiment, step/block 231 can involve integrating two or more models together including, but not limited to, the unbalanced multi-phase distribution system model (per step/block 221), the mathematical model of a solar PV source (per step/block 202), and the mathematical model of an energy storage system (per step/block 211). Moreover, step/block 231 can involve integrating into the composite model one or more of the system load data/forecast (per step/block 212), the energy price data/forecast (per step/block 213), and the distribution system operational constraints (per step/block 303). Also, step/block 231 can involve integrating into the composite model the distribution system component data in the case when the unbalanced multi-phase distribution system model (per step/block 221) is not used by instead the underlying data is used.

At step/block 271, the composite model is updated for a next time step by a composite model updater. In an embodiment, the composite model updater is a stand-alone component of system 200. In another embodiment, the composite model updater is part of the unbalanced multi-phase distribution system composite model generator mentioned with respect to step/block 231.

At step/block 241, an optimal schedule is generated using rolling stochastic-DOPF optimization by a rolling stochastic-DOPF optimizer. Block/step 241 can involve, for example, selecting an objective function, solving the model {t . . .T}, and generating an optimal schedule for all times. In an embodiment, the rolling stochastic-DOPF optimizer is processor-based.

At step/block 251, the schedule for the current time t is implemented by a scheduling controller. Step/block 241 can involve, for example, an optimal operation schedule, control signals to the system, charging/discharging schedules of the ESS, and so forth.

At step/block 261, measurements are taken by measurement devices/sensors. For example, voltages, currents, and so forth can be measured.

The mathematical model of a solar PV source (per step/block 202) and the mathematical model of an energy storage system (per step/block 211), as well as the other models that can be generated in accordance with the present principles (e.g., models for other distribution system components) are also collectively referred to herein as “optimization models” generated by an optimization model generator that is considered to subsume the energy storage system model generator (per step/block 211), the energy source model generator (per step/block 202), and any other model generators described herein.

Regarding the input devices referred to with respect to FIG. 2, the same can include one or more of the input devices shown and described with respect to FIG. 1.

A description will now be given regarding an energy storage model, in accordance with an embodiment of the present principles.

A general model for various types of energy storage systems that are connected to the system through a converter is developed here. It is assumed that the converter of the energy storage system is capable of supplying reactive power too. Thus, the model includes the energy balance of the storage device as well as an operational model for the converter that considers the active and reactive supply capability chart and losses. The state of charge (SOC), i.e., level of remaining energy in the energy storage system, is bounded by its upper and lower limits. The charging and discharging power of the energy storage system can be adjusted at each time interval and have lower and upper limits. It is assumed that the energy storage system should return to its initial SOC at the end of the scheduling horizon. Thus, the energy storage system model constraints are as follows:

$$\begin{matrix}{x}_{es , t} = \{ \begin{matrix}b , & if t = 0 or t = T \\ ( 1 - ϕ ) {x}_{es , t - 1} - {p}_{es , t}^{dis} Δ t , & otherwise\end{matrix} & ( 1 ) \\ {\underline{X}}_{es} < {x}_{es , t} < {\overline{X}}_{es} & ( 2 )\end{matrix}$$

where T is the scheduling horizon and t is the index for time interval, p_{es,t}^{dis} represents the active power discharge from the energy storage system in time interval t, x_{es,t} is the energy storage level of ES in time interval t, go is self-discharge rate of the energy storage system, Xₑₛ and X̅ₑₛ are the lower and upper limits for energy storage level of the ES, respectively, b is the initial energy storage level of the energy storage system, and Δt is the duration of a single time interval.

The capability chart of the energy storage system converter represents the acceptable operation region for the converter, and is modeled as follows:

Pₑₛ≦p_{es,t}≦ P̅ₑₛ (3)

Qₑₛ≦q_{es,t} Q̅ₑₛ (4)

(p_{es,t})²+(q_{es,t})²≦|Sₑₛ^{max}|² (5)

where p_{es,t} and q_{es,t}, respectively, are active and reactive power outputs of the ES at time t, and Pₑₛ and P̅ₑₛ (Qₑₛ and Q̅ₑₛ) are the lower and upper limits for active (reactive) power outputs of the ES, respectively. Although supplying reactive power does not affect the energy level of the ES, it results in power losses that need to be considered in the model.

Losses in energy storage systems can be divided into two main parts: self-discharge of the energy storage systems due to internal resistance of the battery also known as idling losses; and losses in the converter during charging and discharging. Idling losses are very small compared to the charging and discharging losses, and we only consider their impact on the energy storage level of the energy storage system. We approximate the charging and discharging losses based on the associated efficiencies and model as a series resistance (Rₑₛ). For example, 90% charging and discharging efficiencies of an ES result in a round trip efficiency of 81%, which is equivalent to a Rₑₛ with a value of 0.1 pu.

In the operational model of the ES, Rₛₕ corresponds to the energy storage system self-discharge rate that is modeled using φ in Equation (1). Active and reactive power outputs of the energy storage system's converter are as follows:

p_{es,t}=v_{es,t}^{r}i _{es,t}^{r}+v_{es,t}ⁱi_{es,t}ⁱ (6)

q_{est,t}=v_{es,t}¹_{es,t}^{r}−v_{es,t}^{r}i_{es,t}ⁱ (7)

Thus, discharging power of the energy storage system can be written as follows:

p_{es,t}^{dis}=(v_{es,t}^{r}i_{es,t}^{r}+v_{es,t}ⁱi_{es,t}ⁱ)+((i_{es,t})²+(i_{es,t})²)Rₑₛ (8)

Negative p_{es,t}^{dis} means that the energy storage system is charging. Adding Rₑₛ to the model takes into account the power losses due to the supply of active and reactive power by the energy storage system, as follows:

p_{es,t}^{loss}=((i_{es,t}^{r})²+(i_{es,t}ⁱ)²)Rₑₛ (9)

A description will now be given regarding an unbalanced three-phase distribution model, in accordance with an embodiment of the present principles.

The three-phase unbalanced distribution system is formulated in the Cartesian coordinate system. Detailed mathematical models for all components of the system such as lines, transformers, and voltage regulators are written in the rectangular voltage-current format. Real and imaginary parts of the bus voltages in each phase are the optimization problem's variables. Also, active and reactive powers for all other components and devices such as capacitors, loads, and Distributed Energy Resources (DERs) are written in terms of the real and imaginary parts of their currents and associated bus voltages in each phase.

A description will now be given regarding Kirchoff's current law as it is applied to the present principles, in accordance with an embodiment of the present principles.

Kirchhoff's Current Law (KCL) requires that the sum of the currents injected into and withdrawn from each node is equal to zero. KCL can be written in the matrix form for an electrical circuit as follows:

$$\begin{matrix}[ I ] = [ Y ] [ V ] & ( 10 ) \\ [ \begin{matrix}{I}^{r} \\ {I}^{i}\end{matrix} ] = [ \begin{matrix}G & - B \\ B & G\end{matrix} ] [ \begin{matrix}{V}^{r} \\ {V}^{i}\end{matrix} ] & ( 11 )\end{matrix}$$

where [Y] is the admittance matrix of the system, G is the bus conductance matrix, G is the bus susceptance matrix, [I] is the vector of net current injection at each node, [V] is the vector of voltages at each node, V^{r} and Vⁱ are the vectors of real and imaginary components of voltage V, respectively. Thus, Iₙ, the complex current injection at node n, can be written as follows:

Iₙ=Σₗ₌₁^{L}Ī_{n,l} (12)

where, Ī_{n,l} is the complex current injection from component l connected to node n, and L is the total number of components connected to node n.

A description will now be given regarding voltage magnitude constraints, in accordance with an embodiment of the present principles.

Voltage magnitudes at each node should always remain within the acceptable limits:

(V^{min})²=V^{r}V^{r}·V^{r}+Vⁱ·Vⁱ≦|V^{max}|² (13)

where V^{max} and V^{min} are the upper and lower limits on the node voltages.

A description will now be given regarding line flow constraints, in accordance with an embodiment of the present principles.

The flow of lines and transformers are constrained as follows:

I_{n,m}^{r}·I_{n.m}^{r}+I_{n,m}ⁱ·I_{n,m}ⁱ≦|I_{n,m}^{max}|² (14)

where I_{n,m}^{r}, I_{n,m}ⁱ, represent real and imaginary parts of currents flowing from node n to node m, and I_{n,m}^{max} represents the maximum current flow from node n to node m. Current flows in terms of the node voltages are written as follows:

$$[ \begin{matrix}{I}_{n , m}^{r} \\ {I}_{n , m}^{i}\end{matrix} ] = [ \begin{matrix}{G}_{n , m} & - {B}_{n , m} \\ {B}_{n , m} & {G}_{n , m}\end{matrix} ] [ \begin{matrix}{V}_{n}^{r} - {V}_{m}^{r} \\ {V}_{n}^{i} - {V}_{m}^{i}\end{matrix} ] \qquad ( 15 )$$

A description will now be given regarding active and reactive power of components, in accordance with an embodiment of the present principles.

Active and reactive power of other components such as capacitors, loads, and DERs are written in terms of the real and imaginary parts of their currents and associated bus voltages at each phase:

P=v^{r}i^{r}+vⁱiⁱ (16)

Q=vⁱi^{r}−v^{r}iⁱ (17)

A description will now be given regarding a solar PV model, in accordance with an embodiment of the present principles.

Solar PV generation is modeled as a constant power source and the output power is calculated based on the node voltage using Equation (16). It is assumed that the solar PV power is an exogenous input to the model.

A description will now be given regarding an objective function, in accordance with an embodiment of the present principles.

In one embodiment, minimization of total distribution system losses is considered as one example of the objectives that interest DSOs. In this case, in addition to active power losses in the distribution network branches (i.e., lines and transformers), losses from energy storage devices are also included in the objective function. Thus, total losses of the distribution system are formulated as follows:

$$\begin{matrix}{p}_{loss} = \sum [ real ( {V}_{n} {I}_{n , m}^{*} - {V}_{m} {I}_{n , m}^{*} ) ] + {p}_{es}^{loss} \\ = \sum [ ( {V}_{n}^{r} - {V}_{m}^{r} ) {I}_{n , m}^{r} + ( {V}_{n}^{i} - {V}_{m}^{i} ) {I}_{n , m}^{i} ] + {p}_{es}^{loss}\end{matrix} \qquad ( 18 )$$

I_{n,m}^{r}, I_{n,m}ⁱ are written in terms of voltages using Equation (15), and losses of the ESs are calculated from Equation (9).

It is to be appreciated that minimization of losses is one example of objectives that can be used by the present principles. Other objectives such as minimization of peak demand, total energy costs, and imbalanced power at the point of connection to the grid can be integrated individually or collectively as a multi-objective approach.

Thus, in an embodiment, an optimal schedule can be determined that minimizes total peak demand of the distribution system while maintaining predetermined system variables within corresponding operational limits.

In another embodiment, an optimal schedule can be determined that minimizes total imbalanced power of the distribution system at the point of connection to the grid while maintaining predetermined system variables within corresponding operational limits.

In yet another embodiment, an optimal schedule can be determined that minimizes total energy costs of the distribution system while maintaining predetermined system variables within corresponding operational limits.

A description will now be given regarding an operation methodology, in accordance with an embodiment of the present principles. The description of the operation methodology will commence with a description regarding deterministic multi-interval scheduling followed by a description of stochastic scheduling.

The description will now be given regarding deterministic multi-interval scheduling, in accordance with an embodiment of the present principles.

In this case, the DSO operates the distribution network so that total losses of the system are minimized while all other system variables are kept within their operational limits. Thus, DMI method is formulated as the following optimization problem:

$$Minimize {\sum }_{t = 1}^{T} {p}_{loss , t} \qquad ( 19 )$$

subject to: for ∀tε{1 . . . T}

components' models,

KCL at each node,

voltage limits at each node,

line flow limits. where p_{loss,t} is the total power loss of the system at time interval t. This optimization problem provides a deterministic formulation for the optimal scheduling of distribution systems with DERs and energy storage systems.

A description will now be given regarding stochastic scheduling, in accordance with an embodiment of the present principles.

To consider the uncertainties in demand and solar PV outputs, two stochastic methods are presented here: RSO; and FWI methods.

A description will now be given regarding a rolling stochastic optimization (RSO), in accordance with an embodiment of the present principles.

In the RSO method, the program performs DOPF at each time step for the time window ranging from the current time step to the end of the scheduling horizon. In other words, if the scheduling horizon is T time steps, the optimization problem time window will shrink one time interval at each time step. At each time step, the program updates the measured and forecasted demand and renewable generation data to run the optimization model for the rest of the scheduling horizon. The optimal schedule of the system for the next time interval will be implemented from this optimal solution. The main reason to solve the scheduling problem recursively at each time step is to minimize the effects of renewable energy and demand forecast errors on the optimal schedule. As time passes, we obtain more accurate forecast data and the optimal operation scheduling can be solved for each time step using both known data for current and previous time steps and forecasted data for future time.

A description will now be given regarding a fixed-window iterative (FWI) optimization method, in accordance with an embodiment of the present principles.

In the FWI method, starting from the start time to the end of the scheduling horizon, in each time step the program performs optimal power for the current time interval with a fixed scheduling window. For example, if the total scheduling horizon is T, the scheduling time window will be W time intervals at each time step with the previous time step as the initial state. The length of the window shrinks at the end of the scheduling horizon. Notice that the window length should be selected such that the energy system can return to its initial energy level at the end of the scheduling horizon.

A description will now be given regarding some of the many features of the present principles that enable advantages over the prior art and/or solve an important problem in the art. In an embodiment, the present principles provide modeling of ESS in an unbalanced distribution system capturing losses due to supply of reactive power as well as reactive power supply capability chart. Further, in an embodiment, the present principles provide integration of solar PVs and energy storage systems in a rolling stochastic DOPF and in an unbalanced distribution system. Also, in an embodiment, the present principles provide a new formulation of the unbalanced distribution system optimal power flow to lessen solution time.

A description will now be given regarding some of the many attendant advantages of the present principles. Advantageously, the present principles provide a novel modeling framework for an unbalanced distribution system power flow analysis model, including models for energy storage systems and PV generation sources. Moreover, an analysis of various penetration levels of PV source on the distribution feeder is carried out to understand its effects. Further, the modeling framework is extended to an optimization model (DOPF) to determine the optimal charging and discharging of the ESS, tap and capacitors from the Local Distribution Company's (LDC's) operating perspective. Also, the present principles are more accurate as the models are proposed per-phase basis, representing the unbalanced nature of a distribution system.

Embodiments described herein may be entirely hardware, entirely software or including both hardware and software elements. In a preferred embodiment, the present invention is implemented in software, which includes but is not limited to firmware, resident software, microcode, ocode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in an appendix to the application entitled, “Additional Information”. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

### Appendix to Specification

### Additional Information

Abstract—This paper presents a novel framework for stochastic optimal operation of Energy Storage (ES) systems in coordination with Renewable Energy Resources (RERs) in three-phase unbalanced distribution systems. An efficient three-phase unbalanced Distribution Optimal Power Flow (DOPF) is formulated that can be used for both radial and meshed networks. Mathematical optimization models for ESs are developed and integrated in the DOPF formulation. Then, two stochastic operation methods, Fixed-Window Iterative and Rolling Stochastic Optimization methods, are employed to optimally schedule the operation of resources in distribution networks with uncertainties in demand and RER outputs. The proposed optimization model can also be employed to analyze the effects of integrating RERs and ESs into distribution systems. Some relevant simulation results are presented and discussed to highlight the effectiveness of the proposed method to optimally operate distribution systems with ES and RERs. Presented results show that considerable power loss reductions could be achieved with optimal operation of ESs even in the presence of uncertainties.
Index Terms—Energy storage, distribution systems, stochastic optimization, smart grid, renewable energy, optimal power flow.

I. Introduction

Emerging smart grid technologies have brought new opportunities and challenges to Distribution System Operators (DSO) towards more efficient and sustainable operation of distribution networks. Distributed Energy Resources (DERs), Energy Storage (ES) systems, and Renewable Energy Resources (RERs) offer promising potential for distribution network power loss reductions, if operated properly. However, the integration of RERs into distribution systems can be challenging due to the intermittency of these resources' power outputs, which results in difficulties in the operation scheduling of power systems. In this context, ES systems have attracted attention to deal with the intermittent nature of RERs, improve grid utilization, reduce energy loss, and lower system peak demand [1], [2]. Thus, developing appropriate tools and methods to optimally operate ES in coordination with RERs is vital. These tools should be capable of handling unbalanced distribution systems and consider the stochastic characteristics of RER outputs and demand.

A few works have been presented in the literature that address optimal operation of unbalanced distribution systems with DERs and ES systems. A balanced optimal power flow approximation model was used in [2] to optimally allocate different types of DER units in distribution systems. In [2], a linear approximation of distribution power flow was considered to minimize active power losses in a distribution network with ESs. These formulations are approximate models of distribution networks that fail to capture the unbalanced three-phase nature of these systems. In [3] and [4], deterministic operation scheduling models based on the ABCD parameters modeling of three-phase distribution systems were presented that are appropriate for radial networks without considering uncertainties.

This paper provides a novel methodology to optimize the operation of ESs in three-phase unbalanced radial and meshed distribution networks with RERs. Thus, an

optimization problem that optimally schedules the operation of ESs, while satisfying the operational requirements of the distribution network and system components over a finite time horizon is developed. In addition to the Deterministic Multi-Interval (DMI) optimization problem formulation, two stochastic operation methods, Fixed-Window Iterative (FWI) and Rolling Stochastic Optimization (RSO), are also proposed to consider uncertainties in demand and RERs' outputs. The stochastic methods incorporate new measurements and external data that become available at each time step. One benefit of the proposed methods is that an accurate stochastic model of the uncertainties is not required and these methods can even work with simple predictions of the future values.

The rest of this paper is organized as follows: The optimization problem formulation is presented in Section II, and the operation methodologies that can be adopted by DSOs are introduced in Section III. Section IV presents the test system and discusses the simulation results. Conclusions are presented in Section V.

II. Problem Formulation

This work focuses on the integrated operation scheduling of ES systems in distribution networks with RERs. The objective is to minimize the power losses while meeting all the operational and technical requirements of the distribution systems and ES systems. These requirements include voltage limits on distribution feeders, operating constraints of DERs and ESs, as well as energy balance constraints of ES, which are briefly presented next.

### A. Energy Storage Model

A general model for various types of ES systems that are connected to the system through a converter is developed here. It is assumed that the converter of the ES is capable of supplying reactive power too. Thus, the model contains the energy balance of the storage device as well as an operational model for the converter that considers the active and reactive supply capability chart and losses. The state of charge (SOC), level of remaining energy in the ES, is bounded by its upper and lower limits. The charging and discharging power of the ES can be adjusted at each time interval and have lower and upper limits. It is assumed that the ES should return to its initial SOC at the end of the scheduling horizon. Thus, the ES model constraints are as follows:

$$\begin{matrix}{x}_{es , t} = \{ \begin{matrix}b , & if t = 0 or t = T \\ ( 1 - ϕ ) {x}_{es , t - 1} - {p}_{es , t}^{dis} Δ t , & otherwise\end{matrix} & ( 1 ) \\ {\underline{X}}_{es} < {x}_{es , t} < {\overline{X}}_{es} & ( 2 )\end{matrix}$$

where T is the scheduling horizon and t is the index for time interval. p_{es,t}^{dis} represents the active power discharge from the ES in time interval t; x_{es,t} is the energy storage level of ES in time interval t; φ is self-discharge rate of the ES; Xₑₛ and X̅ₑₛ are the lower and upper limits for energy storage level of the ES, respectively; b is the initial energy storage level of the ES; and Δt is the duration of a single time interval.

The capability chart of the ES converter is shown in FIG. 1, where the green shaded area represents the acceptable operation region for the ES converter, and is modeled as follows:

Pₑₛ≦p_{es,t}≦ P̅ₑₛ (3)

Qₑₛ≦q_{es,t}≦ Q̅ₑₛ (4)

(p_{es,t})²+(q_{es,t})²≦|Sₑₛ^{max}|² (5)

where p_{es,t} and q_{es,t}, respectively, are active and reactive power outputs of the ES at time t; and Pₑₛ and P̅ₑₛ (Qₑₛ and Q̅ₑₛ) are the lower and upper limits for active (reactive) power outputs of the ES, respectively. Although supplying reactive power doesn't affect the energy level of the ES, it results in power losses that need to be considered in the model.

Losses in ES systems can be divided into two main parts: self-discharge of the ES due to internal resistance of the battery also known as idling losses; and losses in the converter during charging and discharging. Idling losses are very small compared to the charging and discharging losses, and we only consider their impact on the energy storage level of the ES. We approximate the charging and discharging losses based on the associated efficiencies and model as a series resistance (Rₑₛ). For example, 90% charging and discharging efficiencies of an ES result in a round trip efficiency of 81%, which is equivalent to a Rₑₛ with a value of 0.1 pu.

The operational model of the ES is shown in FIG. 2. In this model, Rₛₕ corresponds to the ES self-discharge rate that is modeled using (p in (1). Active and reactive power outputs of the ES' converter are as follows:

p_{es,t}=v_{es,t}^{r}i_{es,t}^{r}+v_{es,t}ⁱi_{es,t}ⁱ (6)

q_{es,t}=v_{es,t}^{r}i_{es,t}^{r}−v_{es,t}^{r}i_{es,t}ⁱ (7)

Thus, discharging power of the ES can be written as:

p_{es,t}^{dis}=(v_{es,t}^{r}i_{es,t}^{r}+v_{es,t}ⁱi_{es,t}ⁱ)+((i_{es,t}^{r}²+(i_{es,t}ⁱ)²)Rₑₛ (8)

Negative p_{es,t}^{dis} means that the ES is charging. Adding Rₑₛ to the model takes into account the power losses due to the supply of active and reactive power by the ES, as follows:

p_{es,t}^{loss}=((i_{es,t}^{r})²+(i_{es,t}ⁱ)²)Rₑₛ (9)

### B. Unbalanced Three-Phase Distribution System Model

The three-phase unbalanced distribution system is formulated in the Cartesian coordinate. Detailed mathematical models for all components of the system such as lines, transformers, and voltage regulators are written in the rectangular voltage-current format. Real and imaginary parts of the bus voltages in each phase are the optimization problem's variables. Also, active and reactive powers for all other components and devices such as capacitors, loads, and DERs are written in terms of the real and imaginary parts of their currents and associated bus voltages in each phase.

### 1) Kirchhoff's Current Law

The Kirchhoff's Current Law (KCL) requires that the sum of the currents injected into and withdrawn from each node is equal to zero. KCL can be written in the matrix form for an electrical circuit as follows:

$$\begin{matrix}[ I ] = [ Y ] [ V ] & ( 10 ) \\ [ \begin{matrix}{I}^{r} \\ {I}^{i}\end{matrix} ] = [ \begin{matrix}G & - B \\ B & G\end{matrix} ] [ \begin{matrix}{V}^{r} \\ {V}^{i}\end{matrix} ] & ( 11 )\end{matrix}$$

where [Y] is the admittance matrix of the system, G is the bus conductance matrix, and G is the bus susceptance matrix. [I] is the vector of net current injection at each node, [V] is the vector of voltages at each node. V^{r} and Vⁱ are the vectors of real and imaginary components of voltage V. Thus, Iₙ, the complex current injection at node n, can be written as:

Iₙ=Σₗ₌₁^{L}Ī_{n,l} (12)

where, Ī_{n,l} is the complex current injection from component l connected to node n, and L is the total number of components connected to node n.

### 2) Voltage Magnitude Constraints

Voltage magnitudes at each node should always remain within the acceptable limits:

(V^{min})²=V^{r}V^{r}·V^{r}+Vⁱ·Vⁱ≦|V^{max}|² (13)

where V^{max} and V^{min} are the upper and lower limits on the node voltages.

### 3) Line Flow Constrains

The flow of lines and transformers are constrained as:

I_{n,m}^{r}·I_{n,m}^{r}+I_{n,m}ⁱ·I_{n,m}ⁱ≦|I_{n,m}^{max}|² (14)

where I_{n,m}^{r}, I_{n,m}ⁱ represent real and imaginary parts of currents flowing from node n to node m, and I_{n,m}^{max} represents the maximum current flow from node n to node m. Current flows in terms of the node voltages are written as follows:

$$[ \begin{matrix}{I}_{n , m}^{r} \\ {I}_{n , m}^{i}\end{matrix} ] = [ \begin{matrix}{G}_{n , m} & - {B}_{n , m} \\ {B}_{n , m} & {G}_{n , m}\end{matrix} ] [ \begin{matrix}{V}_{n}^{r} - {V}_{m}^{r} \\ {V}_{n}^{i} - {V}_{m}^{i}\end{matrix} ] \qquad ( 15 )$$

### 4) Active and Reactive Power of Components:

Active and reactive power of other components such as capacitors, loads, and DERs are written in terms of the real and imaginary parts of their currents and associated bus voltages at each phase:

P=v^{r}i^{r}+vⁱiⁱ (16)

Q=vⁱi^{r}−v^{r}iⁱ (17)

### 5) Solar PV Model

Solar PV generation is modeled as a constant power source and the output power is calculated based on the node voltage using (16). It is assumed that the solar PV power is exogenous input to the model.

### C. Objective Function

Minimization of total distribution system losses is considered as one example of the objectives that interest DSOs. In this case, in addition to active power losses in the distribution network branches (i.e., lines and transformers), losses from energy storage devices are also included in the objective function. Thus, total losses of the distribution system are formulated as follows:

$$\begin{matrix}{p}_{loss} = \sum [ real ( {V}_{n} {I}_{n , m}^{*} - {V}_{m} {I}_{n , m}^{*} ) ] + {p}_{es}^{loss} \\ = \sum [ ( {V}_{n}^{r} - {V}_{m}^{r} ) {I}_{n , m}^{r} + ( {V}_{n}^{i} - {V}_{m}^{i} ) {I}_{n , m}^{i} ] + {p}_{es}^{loss}\end{matrix} \qquad ( 18 )$$

I_{n,m}^{r}, I_{n,m}ⁱ are written in terms of voltages using (15), and losses of the ESs are calculated from (9).

III. Operation Methodology

### A. Deterministic Multi-Interval Scheduling

In this case, the DSO operates the distribution network so that total losses of the system are minimized while all other system variables are kept within their operational limits. Thus, DMI method is formulated as the following optimization problem:

Minimize Σₜ₌₁^{T}p_{loss,t}

subject to: for ∀tε{1 . . . T}

components' models, (19)

KCL at each node,

voltage limits at each node,

line flow limits.

TABLE I
SCHEDULING TIME WINDOW AT EACH
TIME STEP FOR RSO METHOD

| time | Scheduling time window | |
|---|---|---|
| t = 1 | {1, 2, 3, | . . . |

| | | |
|---|---|---|
| t = 2 | {2, 3, | . . . |

| | |
|---|---|
| . | . |
| . | . |
| . | . |

| | |
|---|---|
| t = T − 1 | {T − 1, T} |

TABLE II
SCHEDULING TIME WINDOW AT EACH
TIME STEP FOR FWI METHOD

| time | Scheduling time window |
|---|---|
| t = 1 | {1, 2, . . . 1 + W} |

| | |
|---|---|
| t = 2 | {2, 3, . . . 2 + W} |

| | |
|---|---|
| . | . |
| . | . |
| . | . |

| | |
|---|---|
| t = T − 1 | {T − 1, T} |

where p_{loss,t} is the total power losses of the system at time interval t. This optimization problem provides a deterministic formulation for the optimal scheduling of distribution systems with DERs and ESs.

### B. Stochastic Scheduling

To consider the uncertainties in demand and solar PV outputs, two stochastic methods are presented here: RSO and FWI methods.

### 1) Rolling Stochastic Optimization

In the RSO method, the program performs DOPF at each time step for the time window ranging from the current time step to the end of the scheduling horizon. In other words, if the scheduling horizon is T time steps, the optimization problem time window will shrink one time interval at each time step, as presented in Table I. At each time step, the program updates the measured and forecasted demand and renewable generation data to run the optimization model for the rest of the scheduling horizon. The optimal schedule of the system for the next time interval will be implemented from this optimal solution. The main reason to solve the scheduling problem recursively at each time step is to minimize the effects of renewable energy and demand forecast errors on the optimal schedule. As time passes, we obtain more accurate forecast data and the optimal operation scheduling can be solved for each time step using both known data for current and previous time steps and forecasted data for future time.

### 2) Fixed-Window Iterative

In the FWI method, starting from the start time to the end of the scheduling horizon, in each time step the program performs optimal power for the current time interval with a fixed scheduling window. For example, if the total scheduling horizon is T, the scheduling time window will be W time intervals at each time step with the previous time step as the initial state, as presented in Table II. The length of the window shrinks at the end of the scheduling horizon. Notice that the window length should be selected such that the ES can return to its initial energy level at the end of the scheduling horizon.

IV. Simulations

### A. System Description and Assumptions

FIG. 3 shows the IEEE 13 bus distribution test feeder that is used here to carry out the simulations [5]. We added solar PVs to all load buses and an ES to bus 675. The parameters for the ES are summarized in Table III. Solar PVs connected to each node are sized based on the loads connected to that node. Maximum PV power generation at each node is equal to 10% of daily peak demand at that node. It is assumed that the PV panels generate only active power. V^{min} and V^{max} are set to 0.95 and 1.07 p.u. for all nodes, respectively. A daily scheduling horizon with hourly time intervals is assumed here to run

TABLE III
ES PARAMETERS FOR EACH PHASE

| | |
|---|---|
| Capacity (kWh) | 800 |
| Charging power upper limit (kW) | 200 |
| Charging power upper limit (kvar) | 150 |
| Discharging power upper limit (kW) | 200 |
| Discharging power upper limit (kvar) | 150 |
| Initial SOC | 0.7 |
| SOC upper limit | 1.0 |
| SOC lower limit | 0.3 |
| Self-discharge rate | 0.01 |

the simulations.

The optimization models are developed in Python using Pyomo, and solved by the Ipopt software package [7], [8]. The program was run on an Intel(R) Core(TM) i7 CPU at 2.40GHz with 8.00GB of RAM.

### B. Input Data Profile

The 24-hour system load profiles of all the loads are generated using the IEEE RTS load profile [6], assuming the given loads in the original test system represent the peak loads. The observed values and forecast error bounds used in the stochastic simulations are shown in FIG. 4 and FIG. 5 for demand and PV output profiles, respectively. It is assumed that the forecast error bounds widen for longer forecast times. Real-time load data obtained from smart meters and historical data can be used to forecast future values at each time step.

### C. Model Validation

The unbalanced distribution system power flow results of the system are compared to results obtained from OpenDSS [9] and published in [5]. Maximum voltage magnitude and angle errors were 0.015 pu and 0.1 degrees, respectively.

### D. Simulation Scenarios

Five simulation cases are presented here to demonstrate the effect of the proposed method on the operations of distribution systems with ES and solar PVs. Case 0 is the basic power flow results of the system without considering the PVs and the ES. Case 1 is the baseline power flow results without ES in the system. This case helps to compare the system performance when the ES is added to the system. Perfect prediction data is used in Case 2 to minimize the total power losses in 24 hours using the DMI method. The FWI and RSO operation methodologies are respectively applied in Case 3 and Case 4 over randomly generated profiles of the PVs and demand at each time step.

### E. Results

1) Power loss reduction using PV and ES

Table IV presents a summary of the total power losses in the system for all cases. Notice that with a solar PV penetration of 10%, power losses of the system are reduced by more than 7%. When the ES is optimally operated, further reductions of more than 7% in power losses are achieved. Observe that total loss reductions obtained using the RSO method with uncertain input data is very close to the optimal values obtained using the DMI method and perfect predictions. FIG. 6 shows the losses obtained from different operation methods for all cases with PVs. Observe that the RSO method can provide close-to-optimal solutions even with bad forecasts for uncertain inputs. The FWI method also provides solutions that are not far from optimal solutions; however, they do not perform as well as the RSO methods.

Notice that ES contributes to loss reductions in the system mainly due to the capability of the ES converter to supply and absorb reactive power without affecting the ES' stored energy level. Supplying reactive power by the ES increases losses in the ES converter; however, these losses are less than network losses in the network if the same amount of reactive power were supposed to be supplied from the substation.

### 2) Comparison of Power Drawn From Substation

FIG. 7 and FIG. 8, respectively, show total three-phase active and reactive power drawn from the substation for the DMI and the base case. The power drawn from the substation follows a similar pattern as the system losses. Without the ES, the substation active power reaches to a higher peak, whereas the ES shaves the peak and fills the valley during hours 1 to 6. Notice that the ES significantly reduces the reactive power imports

TABLE IV
TOTAL LOSSES IN SIMULATION CASES

| | Total losses | Loss reductions |
|---|---|---|
| Cases | (kWh) | w.r.t. baseline (%) |
| 0) no PV, no ES | 1899.35 | — |
| 1) Baseline (w. PVs, no ES) | 1758.54 | — |
| 2) DMI | 1631.03 | 7.25 |
| 3) FWI | 1652.44 | 6.03 |
| 4) RSO | 1631.40 | 7.23 |

from the substation due to the capability of its converter to supply reactive power.

Reactive power supply by the ES decreases the magnitude of current flowing in the

network, thus lessening total losses in the system.

FIG. 9 and FIG. 10 show SOC of the ES obtained from RSO and FWI methods, respectively. Since the RSO model has approximated information about the future load and PV generation till the end of the scheduling horizon, the ES is first charged during the low demand hours and discharged during high peak demand hours. This keeps the SOC of the ES above 400kWh, which means the SOC never goes below 50%. On the other hand, the FWI method lacks this overall view of the loads and PVs data and discharges the ES during the first few hours, as soon as it is needed. Once the scheduling window covers the load increase in the upcoming few hours, the model starts to charge the ES and operates the ES differently. Notice that the SOC of the ES goes to below 50%; although the SOC is still more than the minimum SOC, but this is considered as a deep discharge with negative impacts on the life of the batteries made of lithium-ion.

V. Conclusions

In this paper, an optimization framework was presented to optimally schedule the operation of ES systems in distribution networks with consideration of uncertainties in demand and renewable energy generation. A three-phase unbalanced optimal power flow formulation was developed and incorporated in the problem to properly model the operations of the system. In addition to the deterministic optimization problem, two stochastic operation methods were presented to solve the optimization problem with uncertainties. It was shown that compared to a baseline power flow without PV and ES, the power losses can be reduced by 7% when 10% PV penetrations are integrated to the grid, and can be further lessened by 7.2% with the aid of the ES. In addition to adjusting active power flow, the ES contributes to total loss reductions by adjusting reactive power flow in the network. The proposed RSO method with uncertain input data yields close-to-optimal solutions as compared to the deterministic model with perfectly predicted input data.

### REFERENCES

[1] C. A. Hill, M. C. Such, D. Chen, J. Gonzalez, and W. M. Grady, “Battery Energy Storage for Enabling Integration of Distributed Solar Power Generation,” IEEE Trans. Smart Grid, vol. 3, no. 2, pp. 850-857, June 2012.
[2] Y. M. Atwa and E. F. El-Saadany, “Optimal Allocation of ESS in Distribution Systems With a High Penetration of Wind Energy,” IEEE Trans. Power Systems, vol. 25, no. 4, pp. 1815-1822, November 2010.
[3] S. Paudyal, C. A. Canizares, and K. Bhattacharya, “Optimal Operation of Distribution Feeders in Smart Grids,” IEEE Trans. Industrial Electronics, vol. 58, no. 10, pp. 4495-4503, October 2011.
[4] I. Sharma, M. Chehreghani Bozchalui, and R. Sharma, “Smart Operation of Unbalanced Distribution Systems with PVs and Energy Storage,” in IEEE Int. Conf. Smart Energy Grid Engin. (SEGE13), 2013.
[5] “IEEE 13 Node Distribution Test Feeders.” [Online]. Available: http://ewh.ieee.org/soc/pes/dsacom/testfeeders.
[6] C. Grigg, “The IEEE Reliability Test System-1996,” IEEE Trans. Power Systems, vol. 14, no. 3, pp. 1010-4020,1999.
[7] W. Hart, C. Laird, J.-P. Watson, and D. Woodruff, Pyomo-Optimization Modeling in Python. Springer, 2012.
[8] A. Wachter and L. T. Biegler, “On the implementation of an interior-point filter line-search algorithm for large-scale nonlinear programming,” Mathematical Programming, vol. 106, no. 1, pp. 25-57, April 2005.
[9] R. C. Dugan, “The Open Distribution System Simulator (OpenDSS),” 2012. [Online]. Available: http://sourceforge.net/projects/electricdss/.

What is claimed is:

1. A method for an energy distribution system having at least one energy storage system and at least one renewable energy resource, the method comprising:
determining distribution optimal power flow optimization models of components of the distribution system, the components at least including the at least one energy storage system and the at least one renewable energy resource;
generating a composite model of the distribution system by integrating therein the distribution optimal power flow optimization models; and
optimally scheduling, using a processor-based scheduling optimizer, an operation of resources in the distribution system using at least one of a fixed-window iterative optimization technique and a rolling stochastic optimization technique applied to the composite model.

2. The method of claim 1, wherein said scheduling step is performed for a system state wherein actual energy demand and actual renewable energy resource outputs of the distribution system are unknown.

3. The method of claim 1, wherein said scheduling step considers effects of integrating into the distribution system at least one of: one or more additional energy storage systems; one or more additional renewable energy resources, and one or more additional loads.

4. The method of claim 1, wherein said determining step comprises formulating an energy storage model that models the at least one energy storage system as being connected to the distribution system by an energy converter.

5. The method of claim 4, wherein the energy storage model comprises active and reactive power outputs of the at least one energy storage system.

6. The method of claim 1, wherein said scheduling step is performed to optimize one or more objective functions corresponding to the distribution system.

7. The method of claim 1, wherein said scheduling step is recursively performed at each of a plurality of time steps to minimize effects of renewable energy and energy demand forecast errors on an optimal schedule determined by said scheduling step.

8. The method of claim 1, wherein said scheduling step is recursively performed at each of a plurality of time steps, wherein a previous one of the plurality of time steps is used as an initial state for a respective immediately following one of the plurality of time steps.

9. The method of claim 1, wherein said generating step generates the composite model by further integrating therein at least one of system load data, a system load forecast, energy price data, an energy price forecast, weather data, and a weather forecast.

10. The method of claim 1, wherein said generating step generates the composite model by further integrating therein distribution system operational constraints.

11. The method of claim 1, wherein said scheduling step determines an optimal schedule that minimizes total system losses of the distribution system while maintaining predetermined system variables within corresponding operational limits.

12. A non-transitory article of manufacture tangibly embodying a computer readable program which when executed causes a computer to perform the steps of claim 1.

13. A system for performing scheduling for an energy distribution system having at least one energy storage system and at least one renewable energy resource, the system comprising:
an optimization model generator for generating distribution optimal power flow optimization models of components of the distribution system, the components at least including the at least one energy storage system and the at least one renewable energy resource;
a distribution system composite model generator for generating a composite model of the distribution system by integrating therein the distribution optimal power flow optimization models; and
a processor-based scheduling optimizer for optimally scheduling an operation of resources in the distribution system using at least one of a fixed-window iterative optimization technique and a rolling stochastic optimization technique applied to the composite model.

14. The system of claim 13, wherein said processor-based scheduling optimizer optimally schedules the operation of the resources in the distribution system for a system state wherein actual energy demand and actual renewable energy resource outputs of the distribution system are unknown.

15. The system of claim 13, wherein said processor-based scheduling optimizer considers effects of integrating into the distribution system at least one of: one or more additional energy storage systems; one or more additional renewable energy resources; and one or more additional loads.

16. The method of claim 13, wherein said optimization model generator generates an energy storage model that models the at least one energy storage system as being connected to the distribution system by an energy converter.

17. The system of claim 13, wherein said processor-based scheduling optimizer performs a rolling stochastic recursive optimization technique at each of a plurality of time steps to minimize effects of renewable energy and energy demand forecast errors on an optimal schedule determined by said processor-based scheduling optimizer.

18. The system of claim 13, wherein said distribution system composite model generator generates the composite model by further integrating therein at least one of system load data, a system load forecast, energy price data, an energy price forecast, weather data, and a weather forecast.

19. The system of claim 13, wherein said distribution system composite model generator generates the composite model by further integrating therein distribution system operational constraints.

20. The system of claim 13, wherein said distribution system composite model generator determines an optimal schedule that minimizes total system losses of the distribution system while maintaining predetermined system variables within corresponding operational limits.
